(19) United States
(12) Patent Application Publication
(10) Pub. No.: US 2009/0246580 A1
(43) Pub. Date: Oct. 1, 2009

(54) FUEL CELL AND FUEL CELL SYSTEM

(75) Inventors: Shinichiro IMURA, Kobe-shi (JP); Takashi YASUO, Kobe-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/409,069

(22) Filed: Mar. 23, 2009

(30) Foreign Application Priority Data
Mar. 28, 2008 (JP) 2008-086997
Jan. 27, 2009 (JP) 2009-015873

(51) Int. Cl. H01M 8/04; H01M 8/10

(52) U.S. Cl. 429/23; 429/30; 429/22

(57) ABSTRACT

A fuel cell includes: an electrolyte membrane; an anode provided on one face of the electrolyte membrane; a cathode provided on the other face of the electrolyte membrane; an anode chamber, located adjacent to the anode, which stores fuel gas supplied directly to the anode; a water absorbing member, placed within the anode chamber, which absorbs water, transmits the water and does not pass the fuel gas; and a communicating unit which communicates the anode chamber to the exterior via the water absorbing member.

### CROSS-REFERENCE TO RELATED APPLICATIONS

This application is based upon and claims the benefit of priority from the prior Japanese Patent Application No. 2008-086997, filed on Mar. 28, 2008, and Japanese Patent Application No. 2009-015873, filed on Jan. 27, 2009, the entire contents of which are incorporated herein by reference.

### BACKGROUND OF THE INVENTION

1. Field of the Invention

The present invention relates to a fuel cell for generating electric energy by the use of a fuel containing hydrogen.

2. Description of the Related Art

Recently much attention has been focused on fuel cells that feature not only high energy conversion efficiency but also no toxic substance produced by the electricity-generating reaction. Known as one of such fuel cells is the polymer electrolyte fuel cell which operates at temperatures below 100° C.

A polymer electrolyte fuel cell, which has a basic structure of a polymer electrolyte membrane disposed between a fuel electrode (anode) and an air electrode (cathode), generates power through an electrochemical reaction as described below by supplying a fuel gas containing hydrogen to the fuel electrode and an oxidant gas containing oxygen to the air electrode.

### Fuel Electrode:

H₂→2H⁺+2e⁻ (1)

### Air Electrode:

(½)O₂+2H⁺+2e⁻→H₂O (2)

The anode and the cathode are formed by a catalyst layer and a current collector, respectively. And a fuel cell is composed of catalyst layers of the respective electrodes disposed counter to each other in such a manner as to hold a polymer membrane therebetween. The catalyst layer consists of catalysts or carbon particles supporting a catalyst bound together by an ion-exchange resin. The current collectors transfer the electrons through the catalyst layer. serves as a passage for the oxidant gas or the fuel gas.

At the anode, the hydrogen contained in the supplied fuel is decomposed into protons and electrons as expressed in the above formula (1). Of them, the protons travel inside the polymer electrolyte membrane toward the air electrode, whereas the electrons travel through an external circuit to the air electrode. At the cathode, on the other hand, the oxygen contained in the oxidant gas supplied thereto reacts with the protons and electrons having come from the anode so as to produce water as expressed in the above formula (2).

There are cases where water generated at the cathode can reach the anode in a back diffusion through the polymer membrane. And if there is excessive water content near the polymer membrane due to the presence of such generated water, the diffusion of the fuel gas can be impeded, which may lead to a drop in the performance of the fuel cell. On the other hand, if the polymer membrane becomes too dry, the travel of protons will be impeded, which may also result in a drop in the performance of the fuel cell. It is therefore necessary to adjust the amount of water generated in the anode chamber and the cathode chamber in a proper manner.

In a known arrangement to solve this problem, a fuel cell system is provided with cartridges containing water-absorbing polymer material which are connected to the anode chamber and the cathode chamber, respectively. Another known arrangement is applicable to fuel cells in which the fuel gas retained therewithin is consumed. In this arrangement, the gas impurities are discharged by opening a control valve as required and, at the same time, water only is discharged outside by disposing a water absorbing member, which does not pass the gas, in a conduit where water generated at the anode flows.

A still another known arrangement is for fuel cells having a dead-end that has no circulating mechanism or exhaust gas purge mechanism. In this arrangement, water cooled by a part of the members constituting an anode chamber is discharged outside from a water channel provided in the bottom of the anode chamber.

However, it is difficult to use the fuel cell, in which water condensed in the anode chamber is discharged outside through the water channel provided in the bottom of the anode chamber, in mobile equipment whose position can be changing all the time. Moreover, the cooling part can accelerate condensation of water, and if, for instance, the cooling part is positioned above the electrode, it will be possible that a so-called flooding occurs in which the electrode gets covered up by the condensed water dripping down.

### SUMMARY OF THE INVENTION

The present invention has been made in view of the foregoing circumstances, and a general purpose thereof is to provide a technology for preventing a flooding in an anode chamber by the use of a simple structure.

To resolve the foregoing problems, a fuel cell according to one embodiment of the present invention comprises: an electrolyte membrane; an anode provided on one face of the electrolyte membrane; a cathode provided on the other face of the electrolyte membrane; an anode chamber, disposed adjacent to the anode, which stores fuel gas supplied directly to the anode; a water absorbing member, disposed within the anode chamber, which absorbs water, transmits the water and does not pass the fuel gas; and a communicating unit which communicates the anode chamber to outside via the water absorbing member.

By employing this embodiment, the water accumulating on the anode can be reduced by absorbing the water by the water absorbing member even if, for instance, the water is transported to the anode chamber in a back diffusion. Also, the water in the water absorbing member is discharged outside from the communicating unit, so that flooding can be suppressed by a simple structure without the discharge of fuel gas.

On the other hand, when a high-current power generation is performed, a greater number of protons flow through the electrolyte membrane from the anode to the cathode, which in turn increases water moving from the anode to the cathode together with the protons. As a result, there may be cases where the interior of the anode chamber becomes drier in contrast to the condition as described above. Nevertheless, according to this embodiment, the water absorbing member containing water has an effect of humidifying the anode chamber. The resulting effects are: (a) a smaller gradient of water concentration between the two faces of a cell (i.e., between the anode and the cathode) suppresses the amount of water reverse-diffusing from cathode side, and (b) an increase in resistance due to a drying electrolyte membrane is suppressed.

The water absorbing member may be disposed on a face opposite to the anode of the anode chamber. Therefore, when, for instance, the water evaporating from the anode heated by power generation reaches and condenses on the water absorbing member, the condensate water is absorbed by the water absorbing member, and the growth of waterdrops is suppressed. Hence, the occurrence of flooding due to the growth of waterdrops is reduced.

The water absorbing member may be in a sheet shape. This allows a compact forming of the anode chamber.

The water absorbing member may have a larger area than that of the anode. This design ensures reliable suppression of the growth of waterdrops in an area facing the anode.

A plurality of the communicating units may be formed at intervals in a position opposite to an anode chamber side of the water absorbing member. This arrangement ensures a uniform discharge of water in the anode chamber through the communicating units to the outside.

The communicating unit may be surface-treated to prevent cations from being eluted. Thus, even if the waterdrops are formed in the communicating unit, the elution of the cations can be prevented.

The water absorbing member may be formed of ion-exchange resin membrane. This allows the water absorbing member to be formed by the same membrane as the electrolyte membrane that constitutes the cell.

The ion-exchange resin membrane may be provided with an oxygen reduction catalyst on a surface thereof. As a result, the fuel gas, e.g., the hydrogen gas, permeated through the ion-exchange resin membrane reacts with the oxygen inside the water discharge conduit on the oxygen reduction catalyst so as to generate the water. This generated water makes the ion-exchange resin membrane wet, thereby suppressing the permeation of hydrogen thereafter. Also, as the hydrogen does not transmit, the reaction of hydrogen with the oxygen does not take place and therefore excessive water is not produced. Hence, the wet condition of the ion-exchange resin membrane is maintained appropriately.

Another embodiment of the present invention relates to a fuel cell system. This fuel system comprises: a fuel cell; a fuel cartridge including: a gas chamber which is filled with the fuel gas to be consumed by the fuel cell; and a water discharge chamber having a water retaining member that absorbs and retains water; and a connection mechanism which detachably connects the fuel cartridge and the fuel cell. The connection mechanism includes: a gas supply conduit which supplies the fuel gas by communicating the gas chamber and the anode chamber; and a water discharge conduit which communicates the communicating member and the water discharge chamber and which discharges water within the anode chamber to the water discharge chamber through the water absorbing member when connected.

By employing this embodiment, when the fuel cartridge is connected to the fuel cell, the communicating unit and the water discharge chamber are communicated with each other. As a result, the water inside the anode chamber is discharged to the water discharge chamber through the water absorbing member. Since the water retaining member is provided in the water discharge chamber, the rise in humidity of the discharge chamber is suppressed more efficiently than when no water retaining member is provided. As a result, the amount of water storable in the water discharge chamber can be increased. Further, replacing the fuel cartridge anew results in the water discharge chamber, with low humidity, communicated again with the communicating unit. Thus, the performance deterioration of the fuel cell due to the flooding is reduced for a longer length of time. Here, the water inside the anode chamber discharged to the water discharge chamber through the water absorbing member may be not only in the form of liquid but also in the form of water vapor.

Still another embodiment of the present invention relates also to a fuel cell system. This fuel system comprises: a fuel cell; a fuel tank including: a gas chamber which is filled with the fuel gas to be consumed by the fuel cell; a filler inlet through which the fuel gas from outside is filled into the gas chamber; a hydrogen storage alloy, disposed within the gas chamber, which stores the fuel gas; a water discharge chamber having a water retaining member that absorbs and retains water; and an exhaust outlet which opens and closes in linkage with the opening and closing of the filler inlet and which discharges water retained in the water retaining member as water vapor from the water discharge chamber; a gas supply conduit which supplies the fuel gas from the gas chamber to the anode chamber; a water discharge conduit which communicates the communicating member and the water discharge chamber and which discharges water within the anode chamber to the water discharge chamber through the water absorbing member; and a gating mechanism which opens and closes the gas supply conduit and the water discharge conduit. The gating mechanism includes: a first gating unit which opens the gas supply conduit during power generation by the fuel cell and closes the gas supply conduit during filling of the gas chamber with the fuel gas; and a second gating unit which opens the water discharge conduit during power generation by the fuel cell and closes the water discharge conduit during filling of the gas chamber with the fuel gas.

According to this embodiment, when the fuel cell generates electric power, the communicating unit and the water discharge chamber are communicated with each other. As a result, the water inside the anode chamber is discharged to the water discharge chamber through the water absorbing member. Since the water retaining member is provided in the water discharge chamber, the rise in humidity of the discharge chamber is suppressed more efficiently than when no water retaining member is provided. As a result, the amount of water storable in the water discharge chamber can be increased. When the fuel gas is filled into the gas chamber, the hydrogen storage alloy for storing the hydrogen and the like generates heat. Utilizing this heat generated from the hydrogen storage alloy, the discharging of the water inside the water discharge chamber is facilitated through the evaporation of water in the water discharge chamber.

The water retaining member may have a higher water absorption rate than that of the water absorbing member. As a result, the humidity of the water absorbing member at a communication unit side drops and the transmission of water from the anode chamber is prompted. Thus, the water inside the anode chamber is actively discharged.

It is to be noted that any arbitrary combinations or rearrangement of the aforementioned structural components and so forth are all effective as and encompassed by the embodiments of the present invention.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is an exploded perspective view of a fuel cell according to a first embodiment of the present invention;

FIG. 2 is a cross-sectional view taken along the line A-A′ of FIG. 1;

FIG. 3 schematically illustrates a rough structure of a fuel cell system according to a second embodiment of the present invention;

FIG. 4 is a cross-sectional view of a major portion of a communicating conduit and its proximity thereof in a fuel cell according to a second embodiment of the present invention; and

FIG. 5 schematically illustrates a rough structure of a fuel cell system according to a third embodiment of the present invention.

### DETAILED DESCRIPTION OF THE INVENTION

The invention will now be described by reference to the preferred embodiments. This does not intend to limit the scope of the present invention, but to exemplify the invention.

Hereinbelow, the embodiments will be described with reference to the accompanying drawings. Note that in all of the Figures the same reference numerals are given to the same components and the description thereof is omitted as appropriate.

### First Embodiment

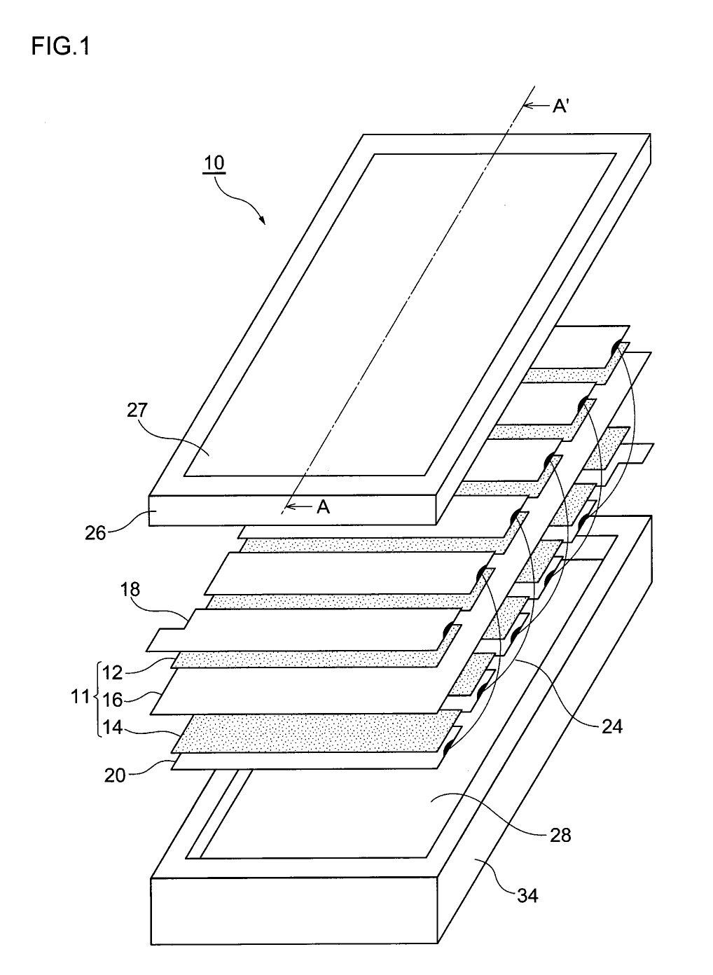

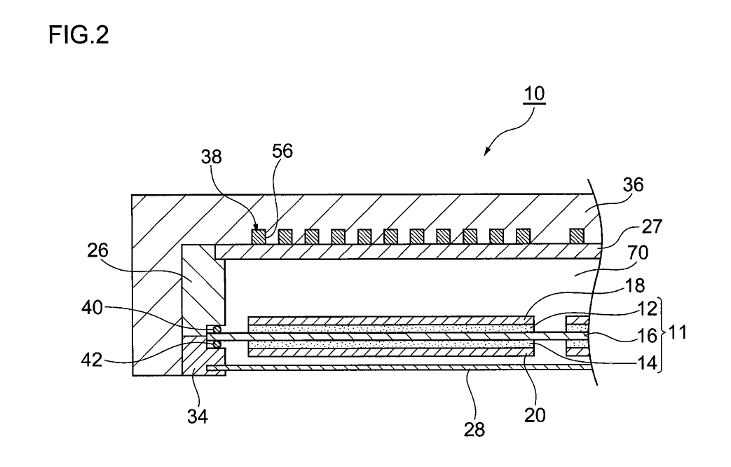

FIG. 1 is an exploded perspective view of a fuel cell according to a first embodiment of the present invention. FIG. 2 is a cross-sectional view taken along the line A-A′ of FIG. 1.

The fuel cell 10 has a plurality of cells 11, which are disposed in a planar arrangement. Each cell 11 comprises a membrane electrode assembly that includes an anode catalyst layer 12, a cathode catalyst layer 14, and an electrolyte membrane 16 interposed between the anode catalyst layer 12 and the cathode catalyst layer 14. Hydrogen is supplied to the anode catalyst layer 12, whereas air is supplied to the cathode catalyst layer 14. The fuel cell 10 generates power by an electrochemical reaction between the hydrogen and oxygen in the air.

The electrolyte membrane 16, which preferably displays an excellent ion conductivity in damp or wet condition, functions as an ion-exchange membrane for the transfer of protons between the anode catalyst layer 12 and the cathode catalyst layer 14. The electrolyte membrane 16 is formed of a polymer material such as a fluorine-containing polymer or nonfluorine polymer. The polymer material that can be used is, for example, a sulfonic acid type perfluorocarbon polymer, polysulfone resin, or perfluorocarbon polymer having a phosphonic acid group or carboxylic acid group. An example of the sulfonic acid type perfluorocarbon polymer is Nafion (made by DuPont: registered trademark) 112. Also, examples of the nonfluorine polymers are a sulfonated aromatic polyether ether ketone, a polysulphone and the like.

The electrolyte membrane 16 is joined with one face of the anode catalyst layer 12, and a current collector 18 is joined with the other face of the anode catalyst layer 12. This structure can be made by first forming an anode catalyst layer 12 on an electrolyte membrane 16 using a spray coating, screen printing, transfer process, or the like and then hot-pressing the current collector 18 on top of the anode catalyst layer 12. An anode-side gasket 40 is provided on the periphery of the electrolyte membrane 16 on the side of the anode catalyst layer 12. An anode housing 26, which is in a frame shape, is provided with the anode-side gasket 40 supporting it.

And an anode chamber 70, where the fuel gas, or hydrogen, is stored, is formed by the anode housing 26 and a water absorbing member 27 which is a sheet disposed to cover the top opening of the anode housing 26. Note that a longitudinal end of each current collector 18 is held down by the anode-side gasket 40. The hydrogen stored in the anode chamber 70 is supplied to the anode catalyst layer 12 through the current collector 18.

The material with which to form the anode housing 26 may be a metallic material, such as a stainless-based metal or titanium-based alloy, or a synthetic resin, such as an acrylic, epoxy or glass epoxy resin.

Provided in the anode housing 26 is a fuel filler inlet (not shown) through which hydrogen gas is supplied under pressure difference from a fuel cartridge (not shown) or the like provided outside the fuel cell 10. And hydrogen is supplied as appropriate from the fuel cartridge when hydrogen in the anode chamber 70 drops to a predetermined level.

The electrolyte membrane 16 is joined with one face of the cathode catalyst layer 14, and a current collector 20 is joined with the other face of the cathode catalyst layer 14. The structure of the current collector 20 is the same as that of the current collector 18. A cathode-side gasket 42 is provided on the periphery of the electrolyte membrane 16 on the side of the cathode catalyst layer 14. A cathode housing 34, which is in a frame shape, is provided with the cathode-side gasket 42 supporting it. Note that a longitudinal end of each current collector 20 is held down by the cathode-side gasket 42.

Attached to the main face of the cathode housing 34 is a filter 28 which is provided with an air inlet (not shown) for introducing air. The air flowing in through the air inlet reaches the cathode catalyst layer 14. The material with which to form the cathode housing 34 may be any of the same materials as are cited for the anode housing 26.

Cells 11 are electrically coupled with one another in series. More specifically, a current collector 18 of one of adjacent cells is coupled to a current collector 20 of the other thereof by a wiring 24.

Further, the fuel cell 10 according to the first embodiment has an outer housing 36 which is provided in such a manner as to cover the top side of the anode housing 26 as illustrated in FIG. 2. The outer housing 36 constitutes a part of the interior surfaces of the anode chamber 70. And the outer housing 36 has a plurality of groove-shaped communicating conduits 38 communicating to the exterior and formed therein at intervals in a position opposite to the water absorbing member 27 disposed on the inside thereof.

A description hereinbelow covers a function of the water absorbing member 27 used in this first embodiment.

Characteristics required of the water absorbing member 27 include its capacity to absorb water present in the anode chamber 70, prevent the fuel gas, or hydrogen, from passing therethrough, and allow water to pass therethrough. An ion-exchange resin membrane is an excellent example of material that has such characteristics. Using such a material, the water absorbing member 27 can be formed from a single type of membrane. More specifically, a preferred choice is Nafion 112, 1135, 115, or 117 (made by Du Pont: registered trademark).

In a conventional type of fuel cell, even when the water generated by the cathode catalyst layer 14 is transported to the anode chamber 70 in a back diffusion, the water cannot be discharged by circulation of hydrogen, with the result that the water gradually accumulates to cover the anode catalyst layer 12.

To prevent that, the first embodiment provides the anode chamber 70 with the water absorbing member 27 that absorbs water, thereby reducing the water accumulating on the anode catalyst layer 12. The amount of water to be absorbed by the water absorbing member 27 may be set by selecting an optimum combination of the size and form of a system and the size and material of the water absorbing member. For example, the amount of water absorption may be increased by an increase in absorption area, use of a thicker membrane, or use of an ion-exchange membrane with greater water content. The following description introduces concrete examples.

For example, when the fuel cell 10 generates power at 0.2 A/cm², water is generated at a rate of 0.067 g/cm² h by the cathode catalyst layer 14. Suppose that 1% of the water generated is transported to the anode as the reverse-diffused water. Then the reverse-diffused water occurs at a rate of 6.7×10⁻⁴ g/cm² h. If it is assumed that Nafion 117 (membrane thickness: 183 μm, 360 g/m²) equivalent in volume to the cell area is used as the water absorbing member 27 and the water content is 10%, then water can be absorbed at a rate of 3.6×10⁻³ g/cm². Hence, even when the water cannot be discharged outside through the communicating conduits after passing through the water absorbing member 27, the water absorbing member 27 can absorb water transported to the anode by a back diffusion which may result from at least 5 hours of power generation.

In this first embodiment, communicating conduits 38 are provided on the side opposite to the face of the water absorbing member 27 exposed to the anode chamber 70, in addition to the above-described water absorbing member 27. Thus, water present in the anode chamber 70 is discharged therethrough to the outside after passing through the water absorbing member 27. Also, as the air comes into the communicating conduits 38 after the discharge of water, there results a drop in humidity on the surface of the water absorbing member 27 on the side of the communicating conduits 38, thereby widening the difference of humidity from that inside the anode chamber 70. This increases the water concentration gradient and promotes permeation of water through the water absorbing member 27. As a result, flooding can be suppressed by this simple structure without the discharge of fuel gas.

A plurality of communicating conduits 38 are arranged at intervals on the side of the water absorbing member 27 opposite to the anode chamber 70. This arrangement ensures a uniform discharge of water in the anode chamber 70 through the communicating conduits 38 to the outside.

The water absorbing member 27 is disposed on a side of the anode chamber 70 facing the anode catalyst layer 12, that is, on the internal surface of the outer housing 36. Therefore, when, for instance, the water evaporating from the anode catalyst layer 12 heated by power generation reaches and condenses on the water absorbing member 27, the condensate water is absorbed by the water absorbing member 27, and the growth of waterdrops is suppressed. Hence, the occurrence of flooding due to the growth of waterdrops is reduced.

On the other hand, when a high-current power generation is performed, a greater number of protons flow through the electrolyte membrane 16 from the anode catalyst layer 12 to the cathode catalyst layer 14, which in turn increases water (entrained water) moving from the anode catalyst layer 12 to the cathode catalyst layer 14 together with the protons. As a result, there may be cases where the interior of the anode chamber 70 becomes drier in contrast to the condition as described above. Nevertheless, in the fuel cell 10 according to the first embodiment, the water absorbing member 27 containing water has an effect of humidifying the anode chamber 70. The resulting effects are: (a) a smaller gradient of water concentration between the two faces of a cell 11 (i.e., between the anode catalyst layer 12 and the cathode catalyst layer 14) suppresses the amount of water reverse-diffusing from the cathode side, and (b) an increase in resistance due to a drying electrolyte membrane 16 is suppressed.

Moreover, the water absorbing member 27, which is in a sheet shape, allows a compact forming of the anode chamber 70. Also, the water absorbing member 27 according to this first embodiment is larger in area than the anode catalyst layer 12. This design ensures reliable suppression of the growth of waterdrops in the area facing the anode catalyst layer 12 as well as absorption of more water.

The communicating conduits 38 are surface-treated with a resin, such as Teflon®, or carbon to prevent the elution of cations. If the outer housing 36 is made of a metallic material, such as stainless-based or titanium-based metals, then waterdrops, if formed, in the communicating conduits 38 can cause the elution of cations. And if the waterdrops containing cations come in contact with the water absorbing member 27, there may result a degradation of the water absorbing member 27, making the permeation of water harder. Therefore, the surface treatment of the communicating conduits 38 effectively prevents the above-mentioned degradation of the water absorbing member 27.

The communicating conduits 38 are filled with wicking material 56 that can suck up water from the water absorbing member 27. This arrangement provides an easy transpiration of water by reliably transporting water from the water absorbing member 27 to the outside through the communicating conduits 38. The material for the wicking material 56 may be a porous material, such as cloth, nonwoven fabric, particle sintered compact, fiber bundle, sponge, and the like.

### Second Embodiment

A fuel cell according to a second embodiment differs markedly from the first embodiment in that there is provided a communication conduit connected to a fuel cartridge above the absorbing member. Hereinbelow, a description is given mainly of features different from those of the first embodiment and the repeated description thereof will be omitted as appropriate.

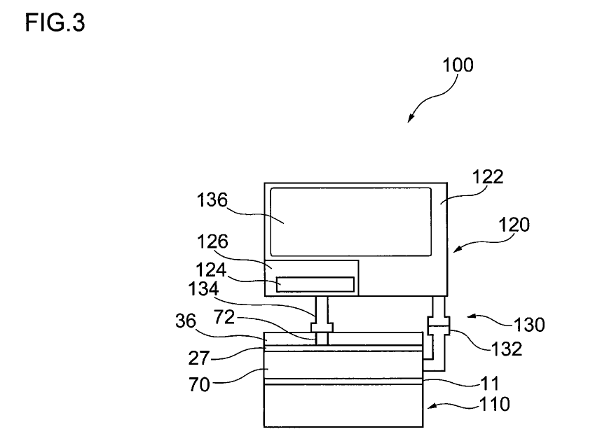

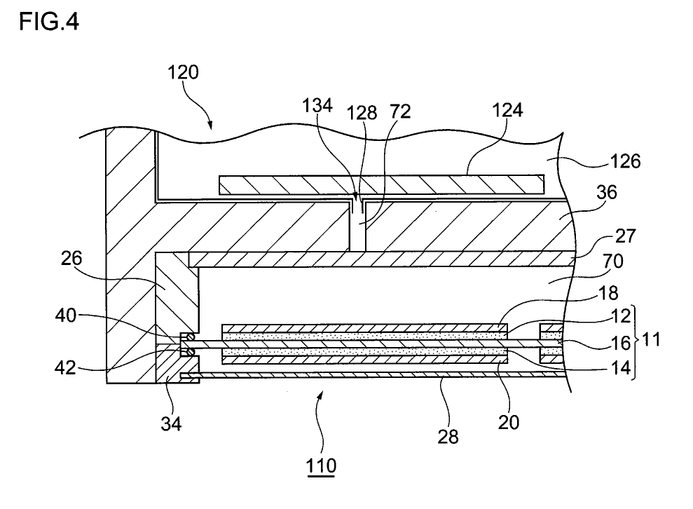

FIG. 3 schematically illustrates a rough structure of a fuel cell system according to a second embodiment of the present invention. FIG. 4 is a cross-sectional view of a major portion of a communicating conduit and its proximity thereof in a fuel cell according to the second embodiment. A fuel cell system 100 according to the second embodiment includes a fuel cell 110, a fuel cartridge 120, and a connection mechanism 130 for detachably connecting the fuel cell 110 and the fuel cartridge 120. The fuel cartridge 120 has a gas chamber 122 filled with hydrogen gas to be consumed by the fuel cell 110, and a water discharge chamber 126 provided with a water retaining member 124 that absorbs and retains water.

The connection mechanism 130 includes a gas supply conduit 132 which supplies the fuel gas by communicating the gas chamber 122 and the anode chamber 70 when connected, and a water discharge conduit 134 which communicates a communicating conduit 72 and a water discharge chamber 126 and then discharges water inside the anode chamber 70 to the water discharge chamber 126 through the water absorbing member 27, when connected.

The communicating conduit 72 is provided in an outer housing 36. The fuel cartridge 120 is provided with the water discharge conduit 134 that communicates the discharge chamber 126 to the outside. The detailed description of the water discharge conduit 134 is omitted here but, in essence, inserting a filler inlet 128 into the communicating conduit 72 opens the communicating conduit 72, which makes it possible to discharge the water in the anode chamber 70 through the water absorbing member 27. The connection mechanism 130 may preferably be of such a structure that gas is supplied from the gas supply conduit 132 to the anode chamber 70 when connected and hydrogen gas is not leaked from the gas chamber 122 and the anode chamber 70 when detached. Similarly, the connection mechanism 130 may preferably be of such a structure that the water inside the anode chamber 70 is drained to the water discharge chamber 126 through the water absorbing member 27 when connected.

A drying agent, having a higher absorption rate than that of the water absorbing member 27, such as silica gel, calcium oxide or calcium chloride, is used for the water retaining member 124. When the water in the communicating conduit 72 is absorbed by such a water retaining member 124, the humidity of the water absorbing member at a communication conduit 72 side drops and the transmission of water from the anode chamber 70 is prompted. Thus, the water inside the anode chamber 70 is actively discharged. The connection mechanism 130 according to the second embodiment is structured such that the communicating conduit 72 is naturally blocked when the fuel cartridge 120 is removed from the fuel cell 110. The water absorption capacity is maintained by drying the water retaining member 124 when the fuel cartridge is filled with fuel or by replacing the water retaining member 124 with a new one.

As described above, when the fuel cartridge 120 is connected to the fuel cell 110, the communicating conduit 72 and the water discharge chamber 126 are communicated with each other. As a result, the water inside the anode chamber 70 is discharged to the water discharge chamber 126 through the water absorbing member 27. Since the water retaining member 124 is provided in the water discharge chamber 126, the rise in humidity of the discharge chamber 126 is suppressed more efficiently than when no water retaining member 124 is provided. As a result, the amount of water storable in the water discharge chamber 126 can be increased. Further, replacing the fuel cartridge 120 anew results in the water discharge chamber 126, with low humidity, communicated again with the communicating conduit 72. Thus, the performance deterioration of the fuel cell 110 due to the flooding is reduced for a longer length of time. The communicating conduit 72 may be filled with the wicking material that can suck up water from the water absorbing member 27.

As shown in FIG. 3, a hydrogen storage alloy 136 is provided inside the gas chamber 122 of the fuel cartridge 120 according to the second embodiment. Here, the hydrogen storage alloy 136 can store the hydrogen temporarily by incorporating the hydrogen into a metal, and also can discharge the hydrogen as necessary. Examples of metal/alloy used for the hydrogen storage alloy 136 may be an alloy containing a transition element, such as titanium, manganese, zirconium or nickel, an alloy containing a rare-earth element, niobium or the like, an alloy containing vanadium, magnesium, palladium, calcium or the like, and the like.

As the gas chamber 122 is filled with the hydrogen-containing gas, such a hydrogen storage alloy 136 as described above generates heat when the hydrogen in the gas is incorporated thereinto. By utilizing this heat, it is possible to evaporate the water contained in the water retaining member 124 disposed inside the water discharge chamber 126 adjacent to the gas chamber 122.

Put it in more detail, the hydrogen in the fuel cartridge 120 is consumed and reduced due to the electric power generated by the fuel cell 110 and, at the same time, the amount of water contained in the water retaining member 124 provided inside the water discharge chamber 126 increases. As a result, at a stage when the hydrogen has dropped to a certain degree, the fuel cartridge 120 is detached from the fuel cell 110 so as be filled with hydrogen gas. In so doing, the hydrogen storage alloy 136 generates heat when it absorbs and stores the hydrogen gas filled in the gas chamber 122. Hence, the water retaining member 124 inside the discharge chamber 126 adjacent to the gas chamber 122 gets heated, and one end of the water discharge conduit 134 is so designed as to be opened when filled with the hydrogen gas. As a result, the water evaporated is discharged outside.

Consequently, the water retaining function of the water retaining member 124 is restored every time the hydrogen gas is filled up in the gas chamber 122. As a result, the water generated at the power generation by the fuel cell 110 can be stably discharged outside the fuel cell system 100 for a long period of time. This can suppress the flooding in the fuel cell 110 for a long period of time and can extend the life of the fuel cell system 100 as a whole.

### Third Embodiment

In the fuel cell system 100 according to the second embodiment, the fuel cartridge 120 is so structured as to be detachable from the fuel cell 110. In contrast thereto, a fuel cell system according to a third embodiment differs distinctly from the second embodiment in that the fuel cell system is comprised of a fuel tank which is fixed to the fuel cell 110 so that normally the fuel tank cannot be removed.

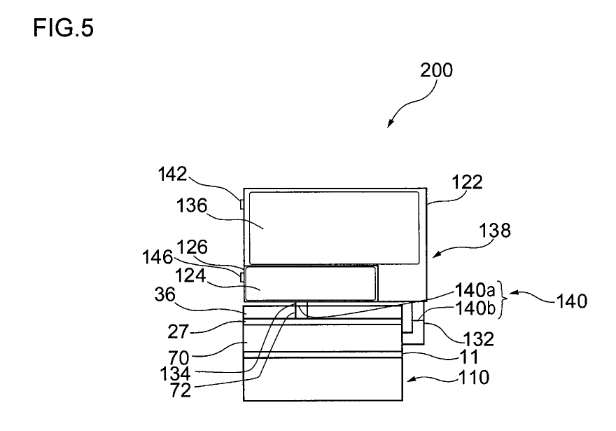

FIG. 5 schematically illustrates a rough structure of the fuel cell system according to the third embodiment of the present invention. Hereinbelow, a description is given mainly of features different from those of the second embodiment and the repeated description thereof will be omitted as appropriate.

A fuel cell system 200 according to the third embodiment includes a fuel cell 110, a fuel tank 138, a gas supply conduit 132 and a water discharge conduit 134, which are provided between the fuel cell 110 and the fuel tank 138, and a gating mechanism 140 which regulates the flow of gas and water in the gas supply conduit 132 and the water discharge conduit 134. The fuel tank 138 has a gas chamber 122 filled with hydrogen gas to be consumed by the fuel cell 110, and a water discharge chamber 126 provided with a water retaining member 124 that absorbs and retains water.

Similar to the second embodiment, a hydrogen storage alloy 136 is provided inside the gas chamber 122 of the fuel tank 138. A filler inlet 142 through which to supply the hydrogen gas into the gas chamber 122 from outside is provided in a casing that forms the gas chamber 122. A water retaining member 124 according to this third embodiment is of such a shape as to occupy the entire discharge chamber 126. There is also provided an external exhaust outlet 146 through which the water retained in the water retaining member 124 is discharged outside in the form of vapor. Since the water in the water retaining member 124 is discharged outside as water vapor through the external exhaust outlet 146, the external exhaust outlet 146 does not need to be placed underneath the water discharge chamber 126, and may be placed in another proper position by taking into account the positions or structure of the surrounding members or components.

In the fuel cell system 200 according to the third embodiment, the water discharge chamber 126 is disposed between the gas chamber 122 and the anode chamber 70, as shown in FIG. 5. With this structure, even if the hydrogen storage alloy 136 produces heat, the heat will not directly reach the fuel cell 110 and therefore the effect of heat on the fuel cell 110 can be reduced. In particular, the water retaining member 124 provided inside the water discharge chamber 126 functions as a buffer to resist heat transfer, because of the water retained therein.

The hydrogen storage alloy 136 and the water retaining member 124 are arranged so that they come in contact with or very close to a partition separating the gas chamber from the water discharge chamber 126. Such arrangement of the hydrogen storage alloy 136 and the water retaining member 124 achieves efficient heat transfer between the hydrogen storage alloy 136 and the water retaining member 124. In addition, the anode chamber 70 and the water discharge chamber 126 are disposed adjacent to each other, so that the water transfer pathway through which the water is discharged from the anode chamber 70 can be made shorter and therefore the size of the fuel cell system 200 can be made smaller.

The above-described filler inlet 142 and the external exhaust outlet 146 are provided with a communicating mechanism (not shown) which is controllable individually or mutually in linkage with a state of communication with the outside. The communicating mechanism is preferably structured such that the filler inlet 142 and the external exhaust outlet 146 are opened and closed automatically or in linkage with the movement of other members. When the hydrogen gas is filled into the gas chamber 122, the fuel cell system 200 according to the third embodiment can discharge the water inside the water discharge chamber 126 to the outside by having the communicating mechanism and the aforementioned gating mechanism 140 operate in cooperation with each other.

More specifically, when a not-shown gas supply unit is connected to the filler inlet 142, the filler inlet 142 opens by the communicating mechanism of the filler inlet 142 and then the gas supply unit is communicated to the gas chamber 122, thereby filling the gas chamber 122 with the hydrogen gas. When the gas is supplied, the external exhaust outlet 146 also opens and the water inside the water discharge chamber 126 evaporated by the heat generated from the hydrogen storage alloy 136 at the time of filling the gas is discharged outside as water vapor. In this case, the gating mechanism 140 closes gating units 140a and 140b provided in the water discharge conduit 134 and the gas supply conduit 132.

Consequently, the water retaining function of the water retaining member 124 is restored every time the hydrogen gas is filled up in the gas chamber 122 by the gas supply unit. As a result, the water generated at the power generation by the fuel cell 110 can be stably discharged outside the fuel cell system 200 for a long period of time. This can suppress the flooding in the fuel cell 110 for a long period of time and can extend the life of the fuel cell system 200 as a whole.

At the power generation by the fuel cell 110, the fuel cell system 200 closes the filler inlet 142 and the external exhaust outlet 146 by the communicating mechanism and opens the gating units 140a and 140b by the gating mechanism 140. At the time of power generation, namely, when the hydrogen gas is discharged from the hydrogen storage alloy 136, the hydrogen storage alloy 136 absorbs heat and therefore the water discharge chamber 126 and the water retaining member 124 inside this water discharge chamber 126 are cooled. As a result, the temperature of the water discharge chamber 126 becomes lower than that of the anode chamber 70. Thereby, the flow of the water (water vapor) generated in the anode chamber 70 toward the water discharge chamber 126 is accelerated.

### Fourth Embodiment

If the water absorbing member in each of the above-described embodiments is comprised of ion-exchange resin membrane in particular, it is possible for the water absorbing member to permeate the fuel gas, or the hydrogen gas, when the water absorbing member dries excessively. For that reason, in this fourth embodiment the above-described water absorbing member 27 is comprised of an oxygen reduction catalyst on a water discharge conduit 134 side of the sides thereof. As a result, the hydrogen gas permeated through the water absorbing member 27 reacts with the oxygen inside the water discharge conduit 134 on the oxygen reduction catalyst so as to generate the water. This generated water makes the ion-exchange resin membrane wet, thereby suppressing the permeation of hydrogen thereafter. Also, as the hydrogen does not transmit, the reaction of hydrogen with the oxygen does not take place and therefore excessive water is not produced. Hence, the wet condition of the ion-exchange resin membrane is maintained appropriately.

A known platinum-based catalyst may be used as the oxygen reduction catalyst. Different from the cell 11, three is no need for the water absorbing member 27 to generate the electric power and therefore the chemical activity of the water absorbing member 27 may be low. For these reasons, a nonplatinum-based catalyst may be used from the viewpoint of cost. Examples of the nonplatinum-based catalyst are catalysts, whose crystalline property is controlled according to the content of nitrogen and carbon and processing conditions, and the like. However, such examples are not particularly limited to those.

The present invention has been described by referring to each of the above-described embodiments. However, the present invention is not limited to the above-described embodiments only, and those resulting from any combination of them as appropriate or substitution are also within the scope of the present invention. Also, it is understood by those skilled in the art that various modifications such as changes in design may be made, based on their knowledge, in a fuel cell or a fuel cell system of each embodiment and the embodiments added with such modifications are also within the scope of the present invention.

For example, if the hydrogen storage alloy is used for the fuel cartridge according to the second embodiment, the water content contained in the water retaining member or dry material may be evaporated by the heat generated when hydrogen is supplied and thereby the performance of the water discharge chamber in the fuel cartridge may be restored.

Also, in order to improve the water retaining capacity or water absorption capacity, namely in order to increase the surface area, the water retaining member in each of the above-described embodiments may be, for instance, one such that said member is elongated and then laminated or asperities are formed thereon.

Also, the opening and closing timing of the communicating mechanism and gating mechanism 140 is not necessarily linked to each other in a strict manner and may be advanced or delayed partially to the degree that it does not disrupt the normal operation of the fuel cell system.

Also, though there is provided a single communicating conduit 72 outside the outer housing 36 in the second embodiment and the third embodiment, a plurality of communicating conduits 72 may preferably be provided to effectively transport the water generated in the anode chamber 70 to the water discharge chamber 126. In such a case, an arrangement is possible where the wicking material is so placed as to cover the anode and the ion-exchange resin membrane, which does not pass the fuel gas, is provided in a middle of or somewhere along the communicating conduit 72. However, this arrangement results in an increased number and kinds of components and is not preferred. In the light of this, the ion-exchange resin membrane is used for the water absorbing member 27, so that the absorption of the generated water and the leakage, if any, of hydrogen gas to an exhaust chamber can be suppressed using a simplified structure without the provision of another components or material in the communicating conduit.

While the preferred embodiments of the present invention have been described using specific terms, such description is for illustrative purposes only, and it is to be understood that changes and variations may be further made without departing from the spirit or scope of the appended claims.

What is claimed is:

1. A fuel cell, comprising:
an electrolyte membrane;
an anode provided on one face of said electrolyte membrane;
a cathode provided on the other face of said electrolyte membrane;
an anode chamber, disposed adjacent to said anode, which stores fuel gas supplied directly to said anode;
a water absorbing member, disposed within said anode chamber, which absorbs water, transmits the water and does not pass the fuel gas; and
a communicating unit which communicates said anode chamber to outside via said water absorbing member.

2. A fuel cell according to claim 1, wherein said water absorbing member is disposed on a face opposite to said anode of said anode chamber.

3. A fuel cell according to claim 2, wherein said water absorbing member is in a sheet shape.

4. A fuel cell according to claim 3, wherein said water absorbing member has a larger area than that of said anode.

5. A fuel cell according to claim 1, wherein a plurality of said communicating units are formed at intervals in a position opposite to an anode chamber side of said water absorbing member.

6. A fuel cell according to claim 1, wherein said communicating unit is surface-treated to prevent cations from being eluted.

7. A fuel cell according to claim 1, wherein said water absorbing member is formed of ion-exchange resin membrane.

8. A fuel cell according to claim 7, wherein the ion-exchange resin membrane is provided with an oxygen reduction catalyst on a surface thereof.

9. A fuel cell system, comprising:
a fuel cell according to claim 1;
a fuel cartridge including:
a gas chamber which is filled with the fuel gas to be consumed by said fuel cell; and
a water discharge chamber having a water retaining member that absorbs and retains water; and
a connection mechanism which detachably connects said fuel cartridge and said fuel cell,
said connection mechanism including:
a gas supply conduit which supplies the fuel gas by communicating the gas chamber and the anode chamber; and
a water discharge conduit which communicates the communicating member and the water discharge chamber and which discharges water within the anode chamber to the water discharge chamber through the water absorbing member when connected.

10. A fuel cell system, comprising:
a fuel cell according to claim 1;
a fuel tank including:
a gas chamber which is filled with the fuel gas to be consumed by said fuel cell;
a filler inlet through which the fuel gas from outside is filled into the gas chamber;
a hydrogen storage alloy, disposed within the gas chamber, which stores the fuel gas;
a water discharge chamber having a water retaining member that absorbs and retains water; and
an exhaust outlet which opens and closes in linkage with the opening and closing of the filler inlet and which discharges water retained in the water retaining member as water vapor from the water discharge chamber;
a gas supply conduit which supplies the fuel gas from the gas chamber to the anode chamber;
a water discharge conduit which communicates the communicating member and the water discharge chamber and which discharges water within the anode chamber to the water discharge chamber through the water absorbing member; and
a gating mechanism which opens and closes said gas supply conduit and said water discharge conduit, said gating mechanism including:
a first gating unit which opens said gas supply conduit during power generation by said fuel cell and closes said gas supply conduit during filling of the gas chamber with the fuel gas; and
a second gating unit which opens said water discharge conduit during power generation by said fuel cell and closes said water discharge conduit during filling of the gas chamber with the fuel gas.

11. A fuel cell system according to claim 9, wherein the water retaining member has a higher water absorption rate than that of the water absorbing member.

12. A fuel cell system according to claim 10, wherein the water retaining member has a higher water absorption rate than that of the water absorbing member.
